(19) United States
(12) Patent Application Publication
(10) Pub. No.: US 2014/0114525 A1
(43) Pub. Date: Apr. 24, 2014

(54) Method for confinement of an autonomous robot

(71) Applicant: Ali Ebrahimi Afrouzi, San Jose, CA (US)

(72) Inventor: Ali Ebrahimi Afrouzi, San Jose, CA (US)

(21) Appl. No.: 13/656,689

(22) Filed: Oct. 20, 2012

(51) Int. Cl. G05D 1/02

(52) U.S. Cl. CPC G05D 1/0244; Y10S 901/01; Y10S 901/47
USPC 701/23; 901/1; 901/47

(57) ABSTRACT

The present invention discloses a system for confining the movement of a robot such that certain area(s) are temporarily or permanently excluded from its working territory. The system uses light-absorbing, black-out paper stripe(s) capable of a complete absorption of light including infrared. The system also uses a mobile robot equipped with infrared emitters and infrared-reflection detectors that communicate the existence of infrared reflection or the lack of it to the robot's control unit. The control unit controls the wheel drivers and ensures that the robot continues travelling only as long as the reflection of infrared signals are detected from the surface onto which it is headed. In this system therefore, the said black-out papers act as a fence that the robot cannot pass because they prevent the reflection of infrared light from the spot(s) where they are placed and force the robot to stop and change directions when it encounters a black-out stripe.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC ATTACHMENT

Not Applicable

### FIELD OF THE INVENTION

The present invention generally relates to robotics and more specifically to a system that can be used to manipulate the movement of a mobile, autonomous robot, preventing it from entering into undesired area(s).

### BACKGROUND OF THE INVENTION

The invention is related to a method and system for robot localization and its prevention from entering unwanted areas.

Many robot-confinement systems have been proposed in the prior art, all of which limit the robot's working area by confining its movement to a specific physical space. Such systems exist for a variety of robotic applications such as floor cleaning, lawn care, inspection, etc., where it is preferred to fence the robot in a desired space and prevent it from wandering into other unwanted areas.

For example, a robot vacuuming a living room navigates every spot in the room indiscriminately and might enter into areas with obstacles that can entangle its brushes and get it stuck (such as the area around the TV-set where cords and cables are often loose on the floor). Another example would be a robot with a wet cloth attached for the purpose of mopping the hardwood floor in a room in which there is also an area rug on which mopping is undesired. One solution would be to remove the rug or (in the case of the TV-set) unplug all the cables and keep them away, which would be troublesome, interruptive and often times impractical. Thus, it is crucial to have a system that can exclude certain areas from the robot's working zone.

There have been multiple attempts to fulfill this purpose in the prior art, none of which is as accurate and cost-effective as the system proposed in this invention. Among the proposed methods in the prior art are complex navigation systems by means of which a robot moves in a predefined path or is aware of its current location relative to a pre-given map. Aside from the sophisticated computational capacity required for such systems and thus their limitation to expensive hardware, these systems lack easy adaptability to changes in the work area, new areas or introduction of new obstacles in their working area. Furthermore, these robots cannot typically be moved to new rooms or environments that have a completely new map without reprogramming or a significant time for reorientation.

For example, U.S. Pat. No. 4,700,427 (knepper) discloses a method which requires a means for generating the robot's travel path. The said means can be either a manual teaching of the path or an automatic mapping system built into the robot. However, if “the place of use is frequently changed” or the “rooms are modified,” large amounts of data and thus a large memory is needed to store the information of each location's map. Similarly, the system disclosed in U.S. Pat. No. 4,119,900 (Kremnitz) requires sensors and a sophisticated computing system to constantly determine the position of the robot in any given space. Another example of such confinement methods is disclosed in U.S. Pat. No. 5,109,566 (Kobayashi et al.) and U.S. Pat. No. 5,284,522 (Kobayashi et al.) both of which require spatial information to be inputted into the robot for the working area of the robot. These and other similar prior-art systems require not only previous programming (or gradual training related to the work-space of the robot), they need further changes and preparation to handle any future change in the robot's working area. For example, the system disclosed in U.S. Pat. No. 5,341,540 (Soupert et al.) ideally requires the robot to be equipped with a positioning system and its working area to be set up with “marking beacons . . . placed at fixed reference points.” Although capable of avoiding unknown obstacles and returning the robot to its preprogrammed path, this system requires a considerable amount of user set-up of the marking beacons and also a sophisticated computational capacity for the robot. Similar methods, all with at least one of the aforementioned disadvantages, are disclosed in U.S. Pat. No. 5,634,237 (Paranjpe), U.S. Pat. No. 5,537,017 (Feiten et al.) and U.S. Pat. No. 5,548,511 (Bancroft).

A different approach for the confinement of a mobile robot involves the use of a device to define the entire working-area boundary for the robot. An example of such approach is disclosed in U.S. Pat. No. 6,300,737 (Bergvall et al.) in which an electronic bordering method relies on the placement of a cable on or under the ground to separate the inner (working) from the outer (excluded) area. Similarly, U.S. Pat. No. 6,255,793 (Peless et al.) discloses a system that requires a metallic wire to be installed on the ground so that the flow path of electricity can define the borders for the robot's working area. Although such methods can confine the robot to a predetermined area, they are difficult and costly to install, are difficult to move from room to room, and are rather impractical when it comes to excluding multiple small areas from one large area, especially when such excluded areas vary from time to time. Furthermore, such systems are hard to repair if a part of the system breaks especially if such systems are installed underground to avoid their unsightly and breakable nature.

A yet different approach for confining a mobile robot involved the use of signal transmitters to define a barrier for the movement of the mobile robot. Such barrier signals are transmitted primarily along an axis that creates the barrier for the robot. An example of such approach is disclosed in U.S. Pat. No. 6,690,134, (Jones et al.) in which portable barrier signal transmitters are used to emit a signal along an axis; said signal is detected by the robot which relies on an avoidance algorithm to move the robot until such barrier signal is no longer detected. Although this method can confine the movement of the robot by using signals to create linear fences that the robot cannot pass, it has numerous shortcomings and limitations. Firstly, any accidental placement of objects, toys, furniture, pets or humans on the way of the signal, can break the signal and render it useless. For example, while the robot is at work in a house where the barrier signal is assumed to be excluding the living room, a cat might break the signal by laying somewhere along the line or a child might place a toy somewhere along the blocking line, rendering it temporarily useless. Furthermore, the portable transmitter can be accidentally moved or knocked over by humans and pets or even by the robot itself. For example if used at a doorway to exclude a certain room from the robot's working area, the signal-transmitter can be moved or knocked over by children, pets, or even the robot if it approaches the transmitter from the side. Another disadvantage of this method lies in its limitation to linear blocking-signals that cannot be bent or shaped as desired. This makes it extremely difficult to exclude areas within a larger area—for example a rug inside a living room. A single transmitter cannot exclude the rug, unless it excludes the entire area around the rug by creating a fence in front of it. To exclude the rug alone without excluding the areas around it, four of such transmitters would be needed, and to exclude a rug and a table, at least eight of them. This makes the use of such transmitter expensive and impractical. In addition, the reach of such signals cannot be limited unless they are blocked by an object—these signals are linear beams that travel unless blocked by an obstacle or a wall. As a result they often block more area than desired and are thus inaccurate when excluding small area(s) from within a larger area of cleaning. For example, to exclude the TV-set placed along the wall in the middle of a living room (an area with lots of cords and cables), a linear block from wall-wall has to be created in front of the TV-set. This linear signal would block much more area than desired (i.e the entire area from wall to wall parallel to the TV set). A further disadvantage of this method is that such transmitters usually use battery for creating the barrier signal, which in addition to making their operation costly and unfriendly to the environment, puts them at risk of unnoticed-failure when their battery runs out. For example, the transmitter might be on and the barrier signal might be assumed to be in place, while the device runs out of battery, causing unwanted damages to the robot or the environment that the robot is assumed to be avoiding. Lastly, the existence of other IR transmitting devices in the room can create possible interference with the function of this system.

The present invention introduces an improved yet simplified system for excluding certain areas from the robot's travelling path and confining it to the desired area. While this system avoids the disadvantages of the prior art, it can be easily integrated into most existing robots' operation without a need for any modification or preparation of these robots or the confinement system they have in place.

### SUMMARY OF THE INVENTION

In accordance with the present invention a robot confinement system is disclosed comprising: a set of light-absorbing, black-out paper stripes that are laid on the floor in the desired shape to define a barrier; a mobile robot, where said mobile robot is equipped with means for turning in at least one direction, infrared emitters and receivers, a control unit controlling the robot's movement, whereby the control unit runs an algorithm for avoiding spots from which an infrared reflection is not received, said algorithm comprising the step of turning the robot until an infrared reflection is received.

Accordingly, the present invention has multiple objects and advantages.

It is an object of the invention to provide a portable, inexpensive, simplified, malleable and accurate system and method of either confining a robot to a specific area or excluding one or multiple areas from its overall working area.

It is an object of the invention to provide a confinement system which needs no installation.

It is an object of the invention to provide a confinement system that includes the possibility for visually indicating the borders and that can be set up intuitively.

It is an object of the invention to provide a confinement system that will oblige the robot to turn in such a way to avoid the barrier regardless of which side the robot approaches the barrier from.

It is an object of the invention to provide a confinement system that operates regardless of the angle at which the robot approaches the barrier.

It is an object of the invention to provide a confinement system that is not influenced by sunlight, will not interfere with other devices and cannot be interfered by other devices.

It is an object of the invention to provide a confinement system in which the confined area's size and shape can be precisely determined, with no need to exclude extra areas.

It is an object of the invention to provide a confinement system that can easily adapt to new areas or needs, and can be easily removed when not needed.

It is an object of the invention to provide a confinement system that operates with no energy consumption, has an eco-friendly production and operation and creates no hazardous waste.

It is an object of the invention to provide a confinement system that requires almost no maintenance, repair or replacement.

It is an object of the invention to provide a confinement system whose operation cannot be interrupted by battery or electricity failure.

It is an object of the invention to provide a confinement system that can be readily used with most current mobile robots and that can be conjoined with the confinement system present in them.

Among the present invention's preferred embodiment is a robotic, indoor cleaning device similar in type to those disclosed in the U.S. Pat. No. 5,396,347 (Yoo), U.S. Pat. No. 5,293,955 (Lee), U.S. Pat. No. 6,865,447 (Lau et al.), U.S. Pat. No. 5,440,216 (Kim), U.S. Pat. No. 4,306,329 (Yokoi), U.S. Pat. No. 5,787,545 (Colens), U.S. Pat. No. 6,076,226 (Reed), U.S. Pat. No. 5,815,880 (Nakanishi), U.S. Pat. No. 5,613,261 (Kawakami et al.), U.S. Pat. No. 7,555,363 (Augenbraun, et al.), U.S. Pat. No. 6,883,201 (Jones, et al.). One of skill in the art will recognize that the present invention can be used in any number of robotic applications with a need for confinement of the robot's working area. Furthermore, although the preferred embodiments explained herein are for a robot with no navigation system, one of skill in the art will recognize the applicability of the present invention to sophisticated robots with navigation systems and the possibility of conjoining the present invention with other confinement systems used by other robots.

In accordance with an aspect of the present invention a robot confinement system is provided which comprises: A. a mobile robot; B. said mobile robot comprising: infrared emitters; infrared-reflection detectors to receive infrared reflection; means for turning in at least one direction; and a control unit controlling said means for turning the robot; C. whereby the control unit runs an algorithm for avoiding spots from which an infrared reflection is not received, said algorithm being operative to turn the robot in a chosen direction until an infrared reflection is detected by said infrared-reflection detectors D. a set of light-absorbing, black-out paper stripes that can be laid on the floor in the desired shape to absorb and thus eliminate the reflection of infrared and thereby provide a fence that the robot cannot pass.

In accordance with an aspect of the present invention a robot confinement system is provided which comprises: A. a mobile robot; B. said mobile robot comprising: infrared emitters; detectors to receive infrared reflection; means for turning in at least one direction; and a control unit controlling said means for turning the robot; C. whereby the control unit runs an algorithm for avoiding spots from which an infrared reflection is not received, said algorithm being operative to reverse direction which the robot most recently traveled until an infrared reflection is detected by said infrared detectors D. a set of infrared light-absorbing, black-out paper stripes that can be laid on the floor in the desired shape to absorb and thus eliminate the reflection of infrared and thereby provide a fence that the robot cannot pass.

In accordance with yet another aspect of the present invention a robot confinement system is provided using a set of light-absorbing, black-out paper stripes. The system comprises: A. a set of light-absorbing, black-out paper stripes that can be laid on the floor in the desired shape to absorb and thus eliminate the reflection of infrared and thereby provide a fence that the robot cannot pass; B. a mobile robot equipped with any means of mobility and a control unit to control such means; C. Infrared emitters positioned on the bottom of the robot adjacent to infrared detectors, said detectors being operative to detect the reflection of infrared emitted by said emitters and communicate it to the said control unit; D. avoiding spots from which an infrared reflection is not received by implementing an avoidance algorithm on the said control unit to move the robot in a randomly chosen direction until infrared reflection is received again.

Other advantages and features of the invention are clarified by the following detailed description of the invention, which include the relevant drawings and claims.

### BRIEF DESCRIPTION OF DRAWINGS

FIG. 1 is an example of a working environment for the robot vacuum cleaner with no confinement system in place.

FIG. 2 shows the same working environment with black-out paper stripes in place around multiple spots to exclude them from the robot's working area.

FIG. 3 shows a stripe of black-out paper stripes dividing an area by creating a fence that the robot vacuum cleaner cannot pass.

FIG. 4A is a drawing of the robot's underneath, depicting the wheels, the IR transmitters/receivers and other components of the robot.

FIG. 4B is a side-view of the robot, illustrating the wheels and the transmission/reception of IR by the transmitters/receivers.

FIG. 5 shows the control unit, which controls the movement of the wheels based on the input from the IR receivers

FIG. 6 is a flow-chart illustration of the algorithm by which the control unit avoids falling into a loop when avoiding the black-out paper stripes.

FIGS. 7 to 12 capture the reaction of the robot in an encounter with the black-out paper stripes.

### DESCRIPTION OF THE INVENTION

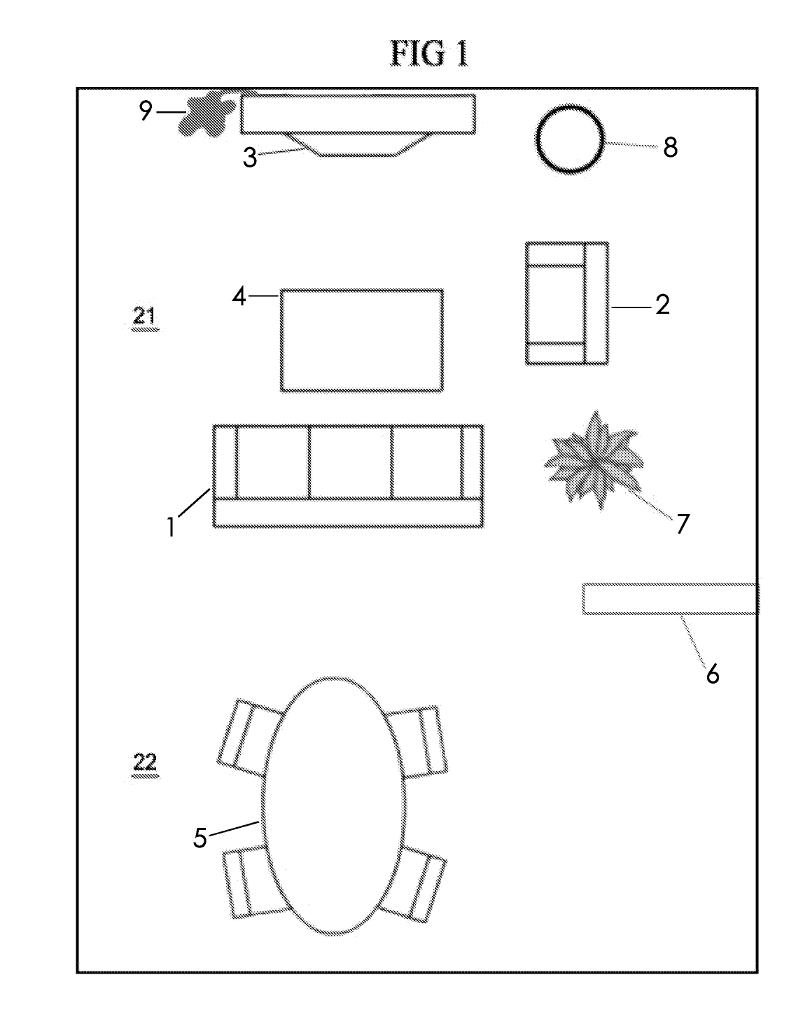

Living room 21 and dining room 22 are depicted in FIG. 1 with various furniture such as couch 1, chair 2, TV 3, coffee table 4, dining table 5, and plant 7. Between the two rooms there is a half-wall 6 that suggests a separation of the living room 21 from the dining room 22 without physically doing so. Behind the TV 3 there is a cable area 9. Inside the living room there is the robot vacuum cleaner 8. There is no confinement system in place which means the robot can wander around the two rooms freely unless in the face of an obstacle.

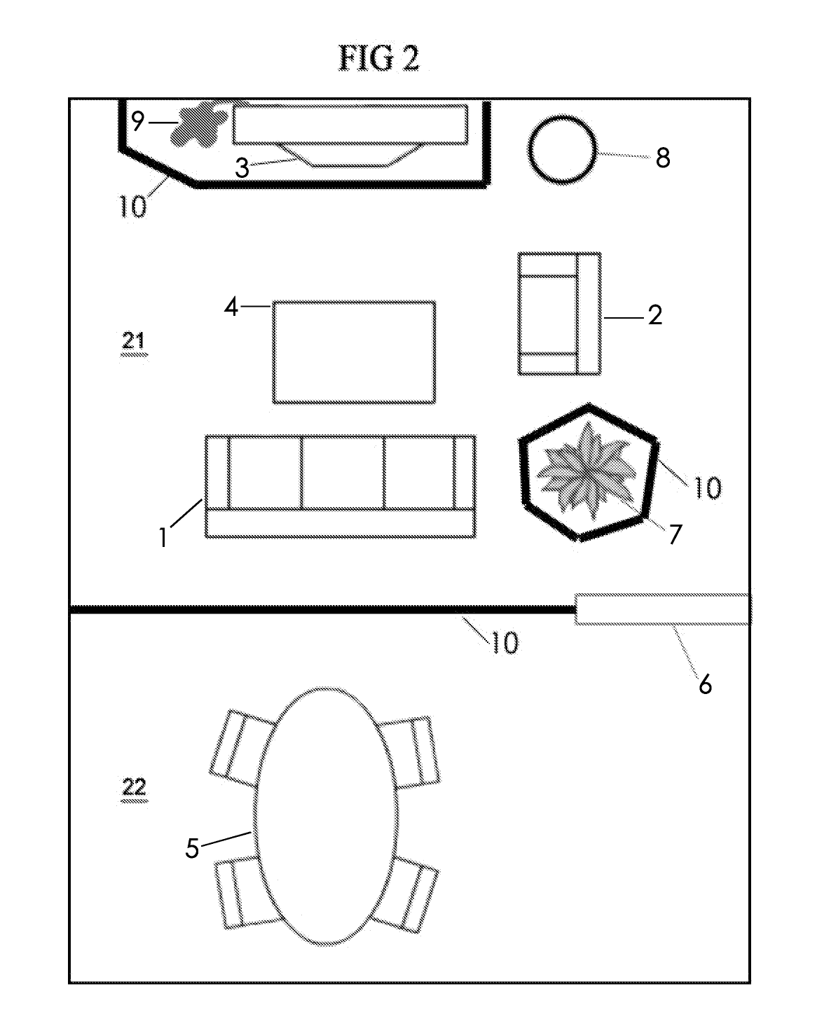

FIG. 2 depicts the same configuration of the two rooms but with multiple black-out paper stripes 10 in place to limit the robot's working space by excluding certain areas from it. Black-out paper stripes 10 are laid in a shape that precisely exclude the TV 3 and cable area 9 while minimizing unwanted exclusion of space in which cleaning is desired.

Black-out paper Stripes 10 are laid to exclude plant 7 from the robot's territory by shaping a hexagonal fence around it. Black-out paper stripes 10 is laid to prohibit the robot's entrance into the dining room 22 all together (evidently, in case the robot is placed and set to work in dining room 22, it would instead be the living room 21 that remains outside of the robot's reach).

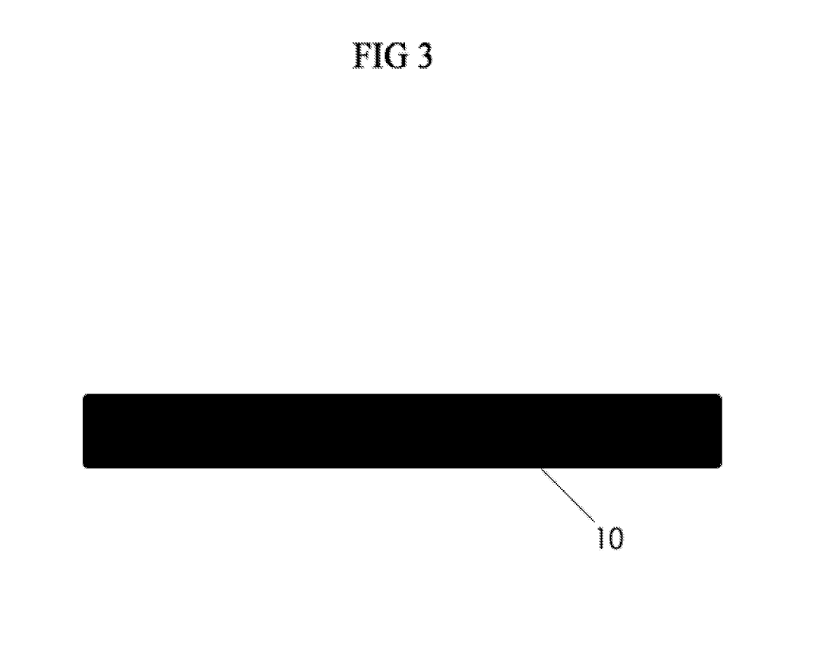

FIG. 3 shows the black-out paper stripe 10, which is simply a stripe of black-out paper that is capable of fully absorbing the light and not reflecting any of it. The stripes can be cut in desired lengths and laid next to each other to form desired shapes.

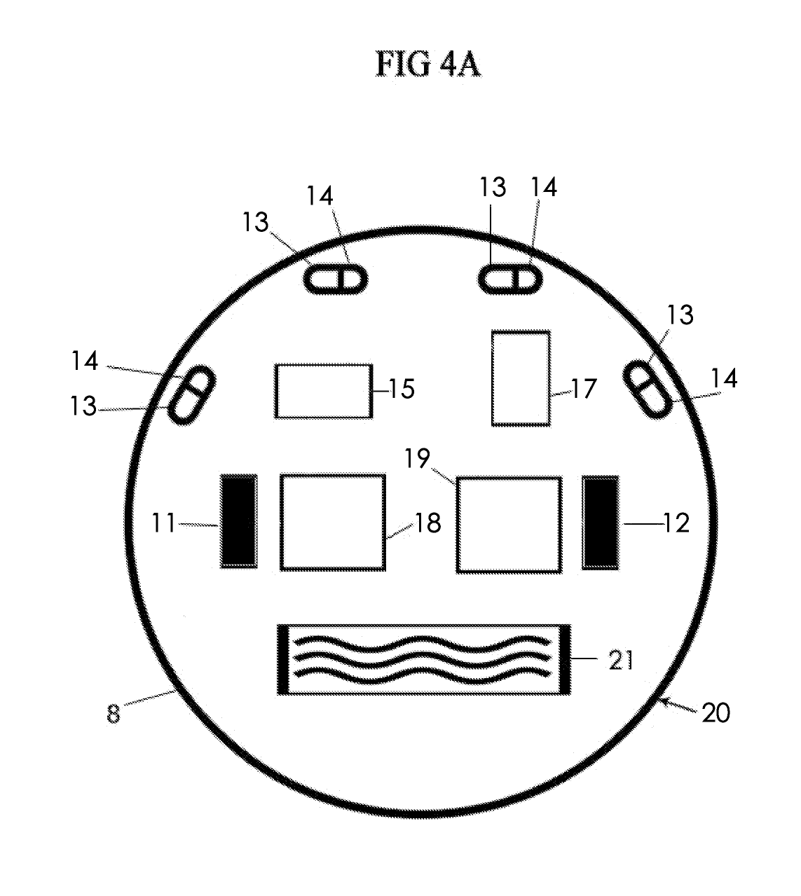

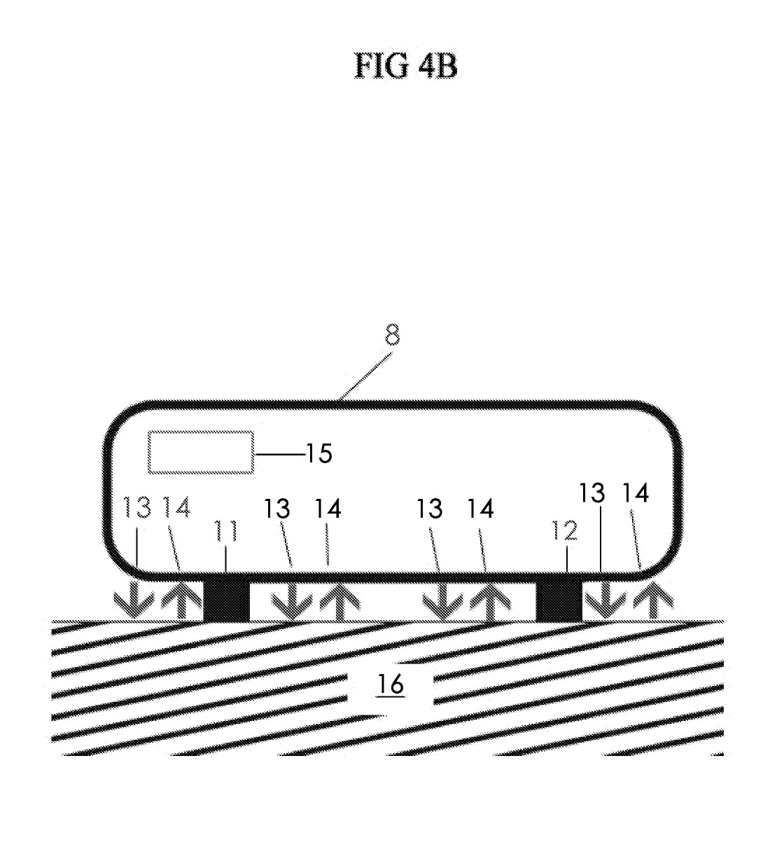

As depicted in FIG. 4A, in the preferred embodiment, the robot 8 comprises the circular shell mounted to a chassis containing a sweeping brush 19, two wheels 11 and 12 mounted on two far ends of a center line while each wheel 11 & 12 can be driven independently to cause the robot to turn.

In its preferred embodiment the robot 8 also comprises four IR signal transmitters 13, four IR signal receivers 14 rechargeable battery 17, control unit 15 and two wheel drivers 18 & 19.

FIG. 4B depicts a side view of the robot moving along the surface 16, as the four infrared transmitters 13 emit infrared and the four infrared receivers 14 communicate its refection to the control unit 15 that is in charge of moving the wheels 11 and 12.

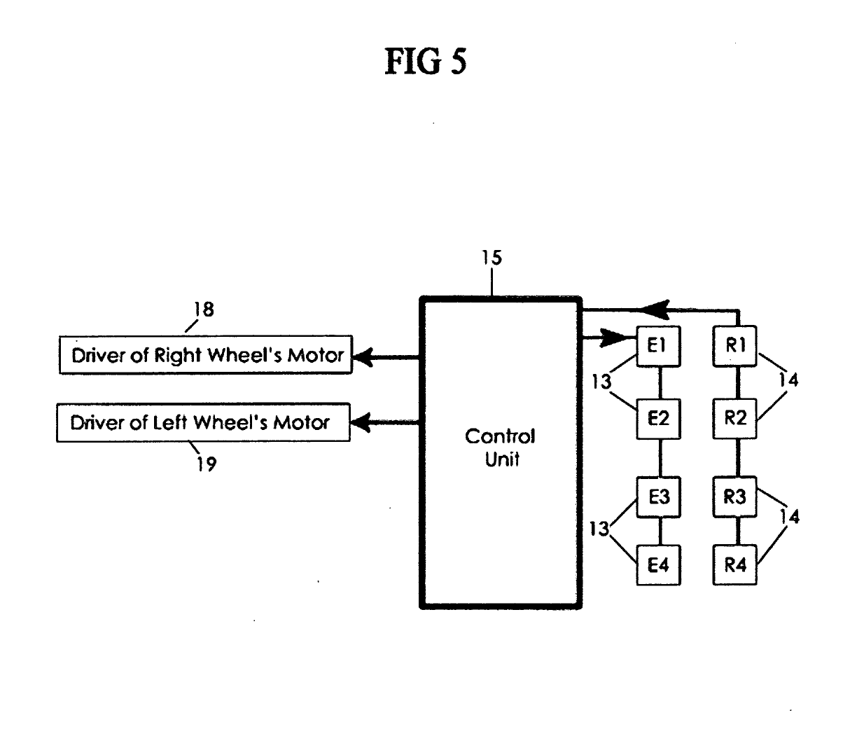

FIG. 5 demonstrates the communication between the IR emitters 13 and receivers 14 with the control unit 15 and the process by which the control unit controls the movement of the wheels 11 and 12. The control unit constantly sends signals to the IR emitters 13 triggering the emission of IR signals to the surface on which the robot 8 is travelling. The IR receivers 14 constantly send signals to the control unit 15 affirming receipt of the IR reflection from the surface on which the robot 8 is travelling. If the control unit 15 stops receiving signals from either one of the receivers 14, it will stop the motor of the driver for both of the robots' wheels 11 and 12.

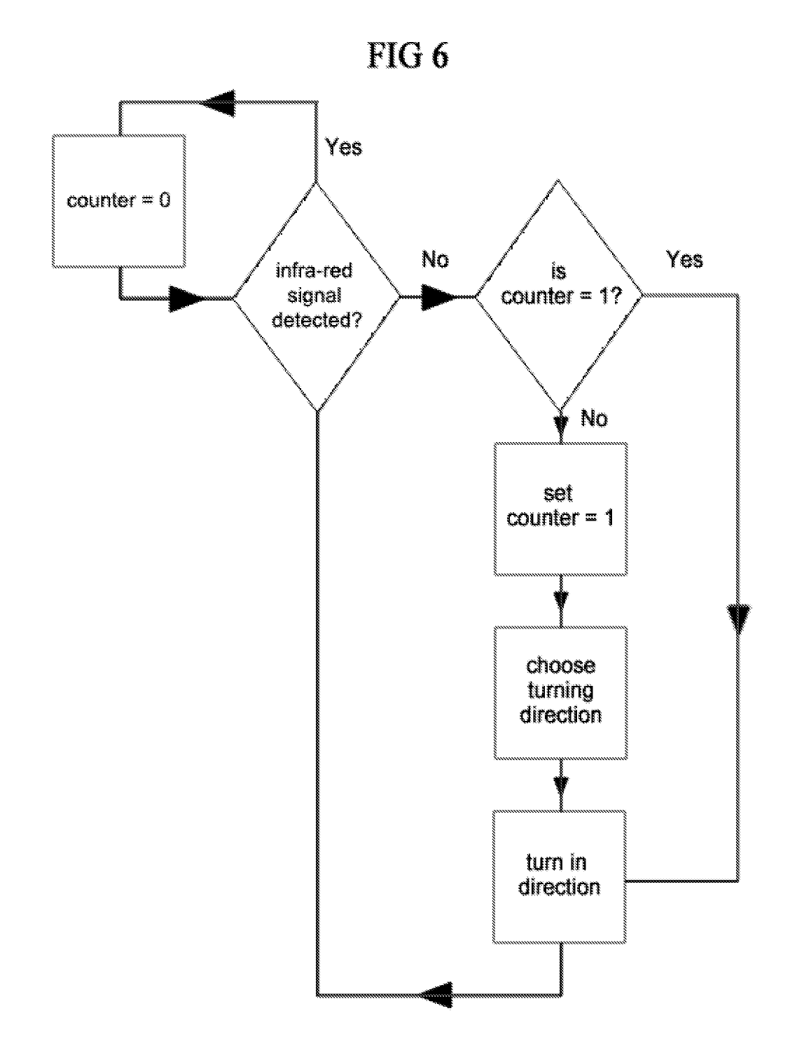

FIG. 6 explains the algorithm that the control unit 15 has been programmed with to prohibit the robot 8 from travelling on surfaces from which no IR reflection is detected, thereby avoiding areas that have been excluded using the black-out paper stripes 10.

The algorithm includes a counter to keep track of the direction to which the robot 8 turns in order to avoid the black-out paper stripes 10. As shown in the algorithm, as long as the receipt of IR signals is communicated to the control unit, the counter remains 0 and the robot continues its movement. If IR reflection is not detected, and the counter is zero—the first moment when the IR reception is interrupted, the control unit selects a direction towards which it turns the robot 8 by moving one of the wheels and keeping the other still. The control unit 15 then sets the counter to 1 to keep the direction of turning in case the IR reception remains absent after an initial turn. This way the robot 8 keeps turning in the same direction until IR reflection is received without falling into a loop. After selecting the direction and setting the counter to one, the control unit 15 turns the robot 8 in either clockwise or counter-clockwise direction. After the robot 8 turns, either it is set on a path on which black-out paper stripes 10 are not laid, or on a path where there is still black-out paper stripes 10 to avoid. If after turning infrared reflection is detected, there will be no more turning and the counter will be set back to zero. If after turning infrared reflection remains absent, the algorithm checks to see if the counter is set to 1. When the control unit 15 detects that the counter is set to 1, it turns the robot in the previously selected direction again. This process is repeated until the IR reflection is detected from the surface onto which the robot 8 is headed.

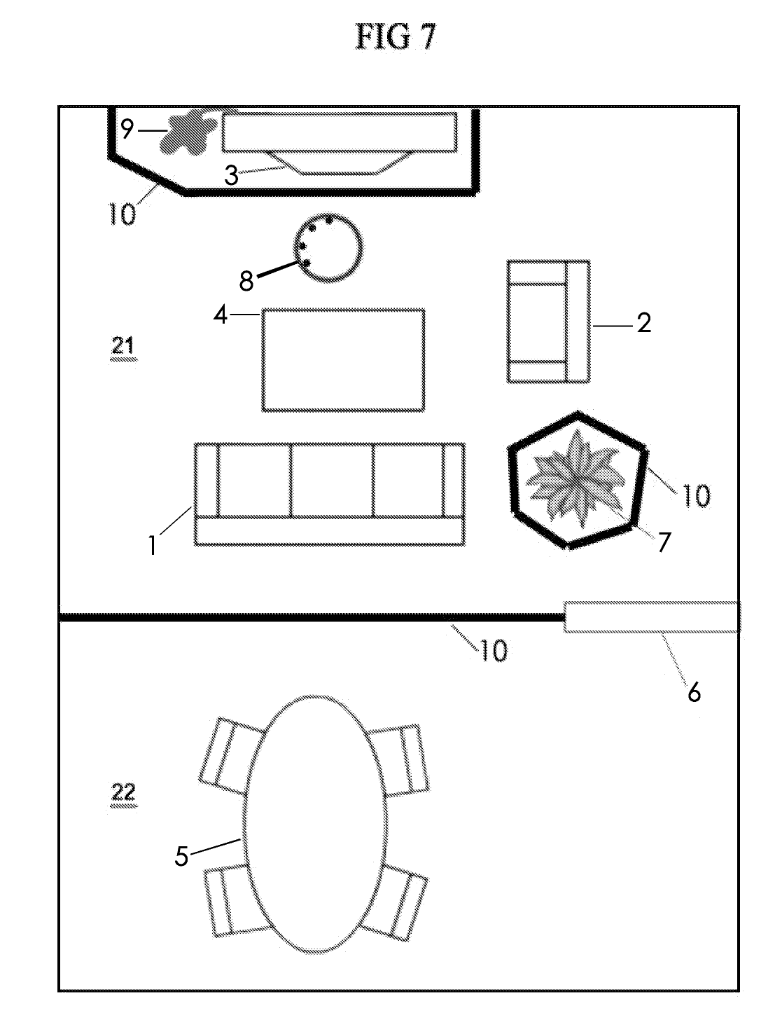

FIG. 7 shows the living room 21 with the black-out paper stripes 10 in place as the robot 8 is approaching the stripe placed in front of the TV 3.

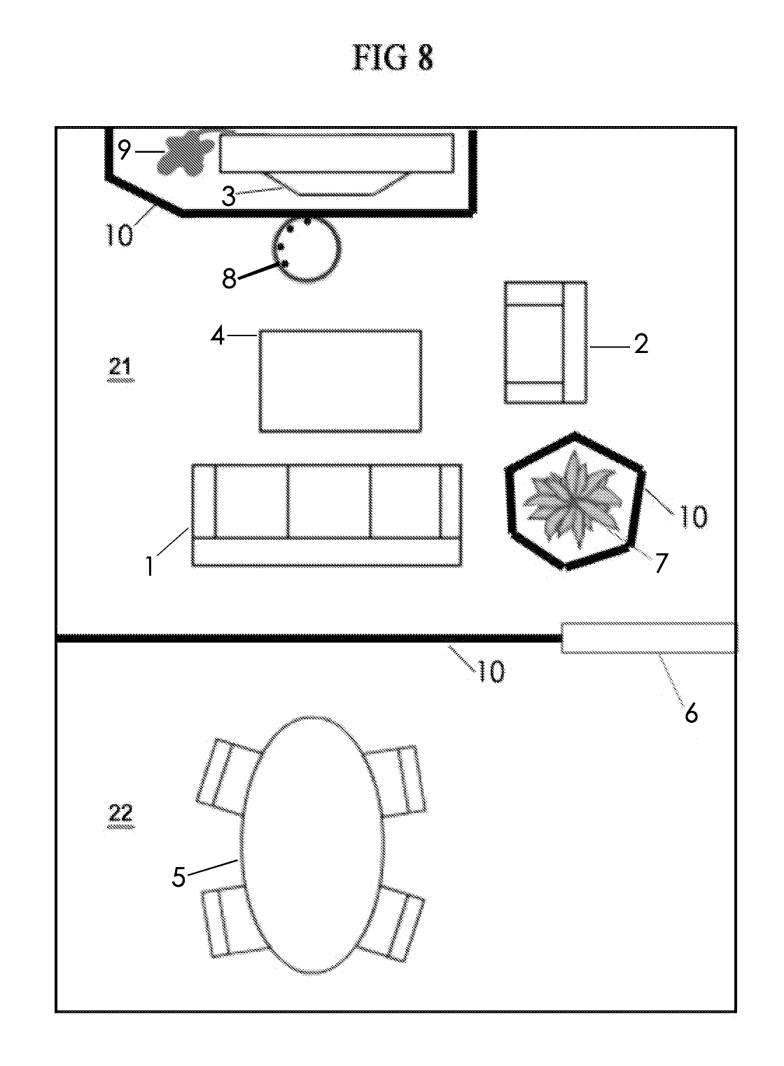

FIG. 8 shows the moment at which the robot 8 reaches the black-out paper stripe 10 which prohibits it from moving further forward by triggering the avoidance algorithm (FIG. 6).

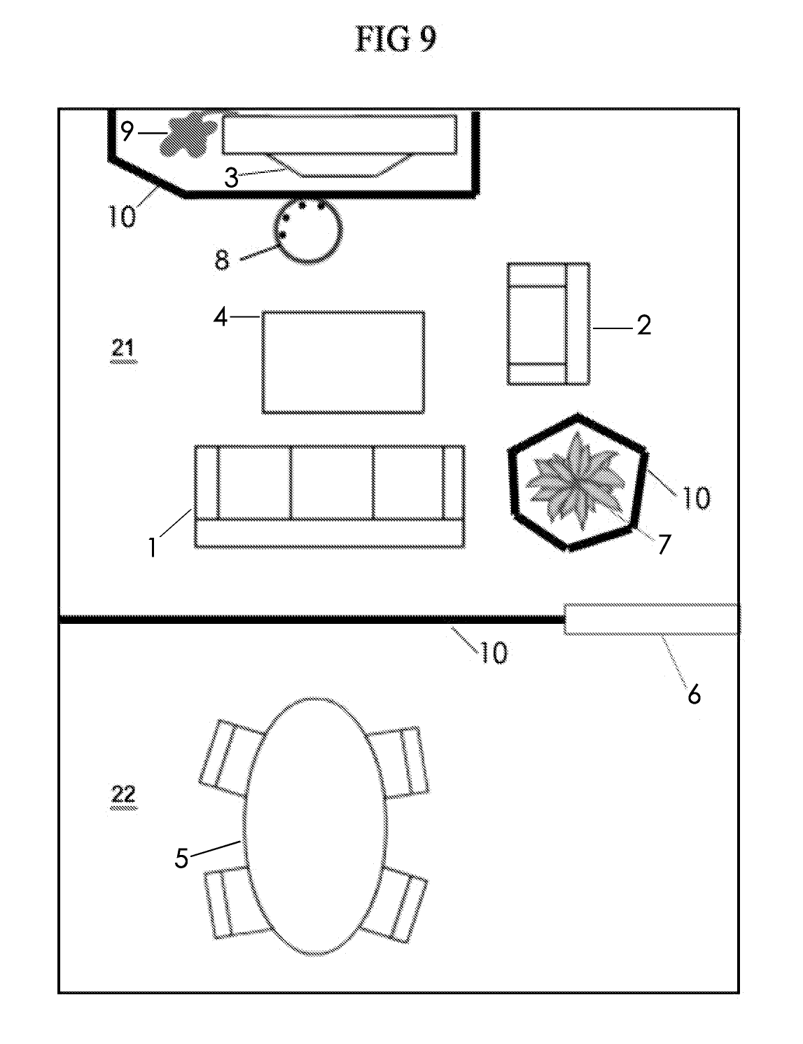

FIG. 9 demonstrates the robot's behavior in order to avoid the black-out paper stripes 10: the robot 8 initially takes a 25-degree turn in the clockwise direction chosen by the avoidance algorithm.

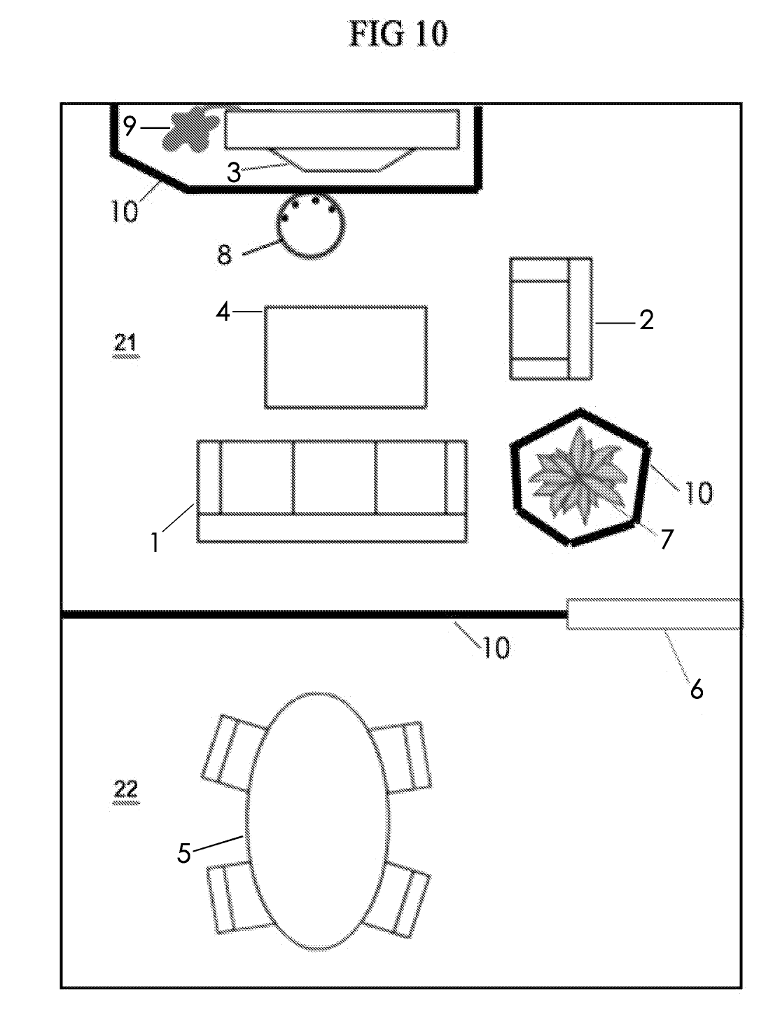

FIG. 10 continues to demonstrate the robot's behavior when encountering the black-out paper stripes 10. Since no IR reflection is detected by the IR receiver 14 on the left side of the robot, the control unit 15 continues to turn the robot 8 in the previously-selected direction.

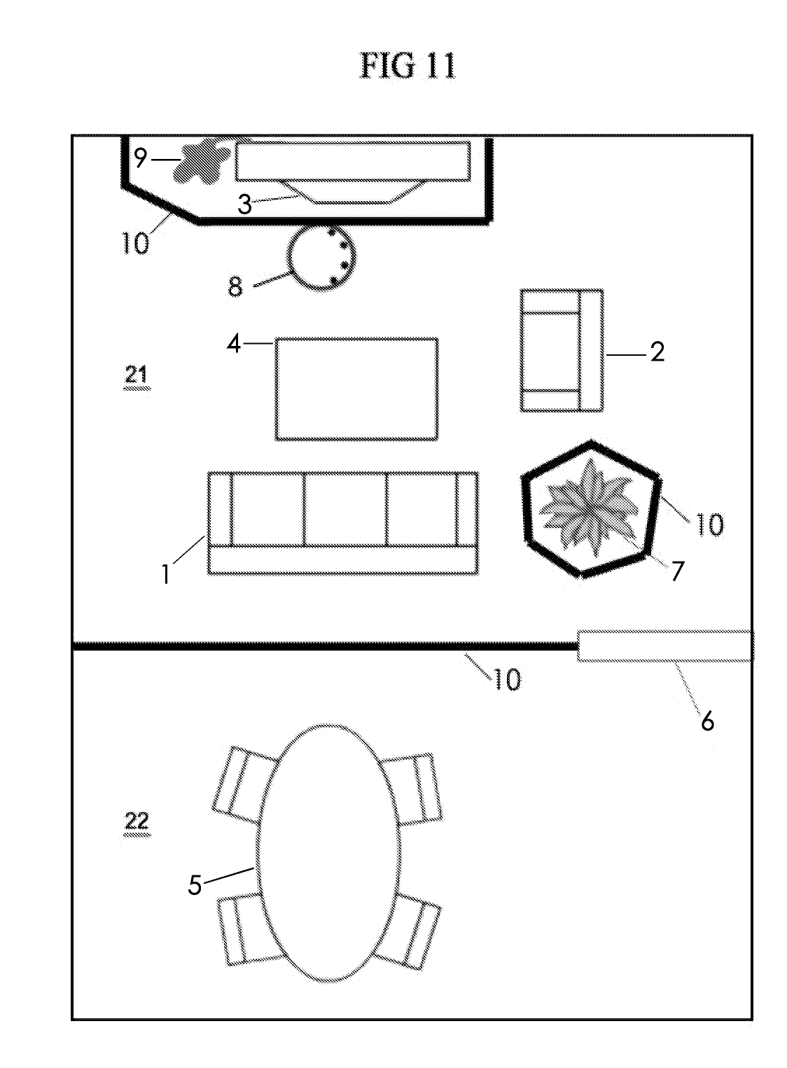

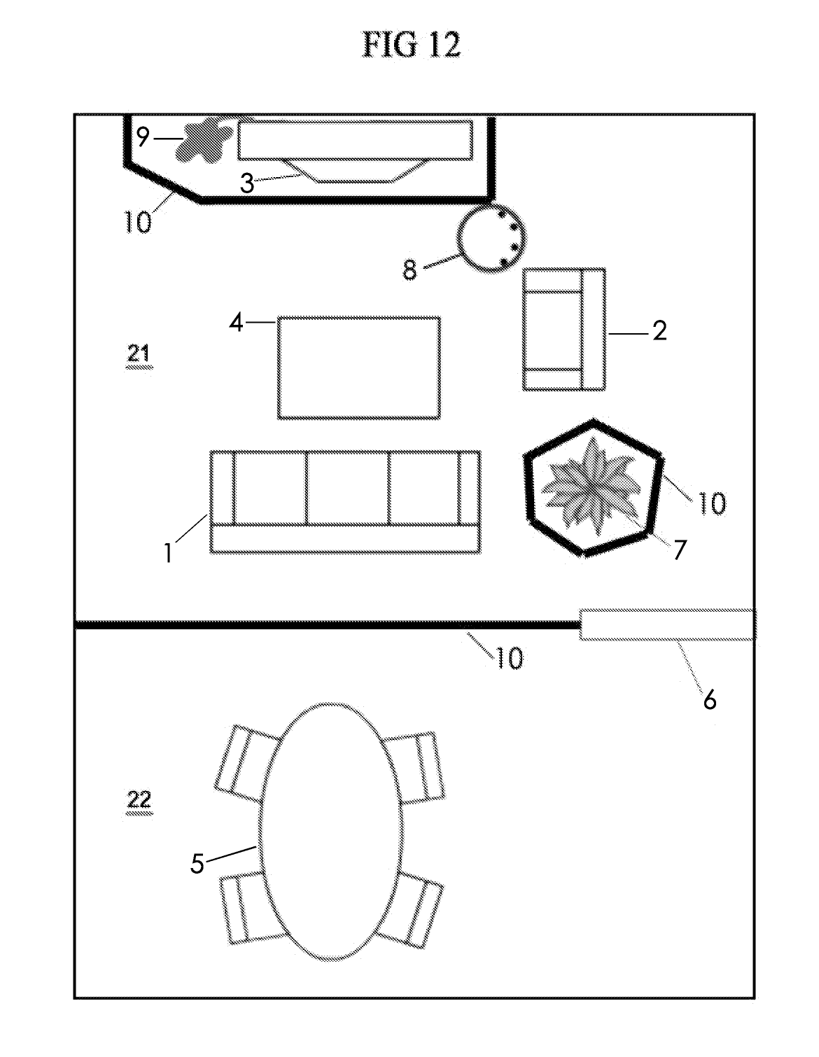

FIG. 11 shows the moment in which the robot 8 has turned enough that it no longer faces black-out paper stripes 10 on its path. It is therefore allowed to move forward, as depicted in FIG. 12.

1. A robot confinement system, comprising:
a. a set of light-absorbing, black-out paper stripe(s) that are capable of complete absorption of light (including infrared signals) and thus allowing no reflection of it.
b. A mobile robot comprising: means for turning in at least one direction; a control unit controlling said means for turning through controlling the wheel drivers; infrared signal emitters and infrared signal detectors adjacent to the emitters capable of detecting the reflection of infrared signal from the surface onto which the robot is headed and communicating the receipt of the reflection or the lack of it to the said control unit; whereby if infrared reflection is not detected by any of the detectors, the control unit runs an algorithm for avoiding the surface onto which the robot is headed, said algorithm being operative to turn the robot in a chosen direction until an infrared reflection is received from the surface onto which the robot is travelling.

2. The robot confinement system of claim 1, wherein the said algorithm is further operative to continue turning the robot in the chosen direction until an infrared reflection is detected from the surface onto which the robot is headed.

3. The robot confinement system of claim 2, wherein said chosen direction of turning determined by the said algorithm can be either clockwise or counterclockwise.

4. The robot confinement system of claim 3, wherein said chosen direction of turning determined by said algorithm is randomly selected.

5. The robot confinement system of claim 3, wherein said chosen direction of turning determined by said algorithm can change if after a predetermined number of turns in that direction, infrared reflection continues to be absent.

6. The robot confinement system of claim 3 wherein the said algorithm can determine the degree of turning the robot.

7. The robot confinement system of claim 3 wherein the degree of turning is programmed into the control unit.

8. The robot confinement system of claim 1, wherein the robot uses any additional means of confinement in conjunction with the confinement system of the current invention.

9. The robot confinement system of claim 1, wherein the said infrared emitters emit a modulated signal at any infrared frequency.

10. The robot confinement system of claim 1, wherein another light beam is used instead of infrared.

11. The robot confinement system of claim 9, wherein operation of said infrared-reflection detectors are substantially omni-directional.

12. The robot confinement system of claim 11, wherein the said mobile robot employs any number above of the said infrared emitter(s) and infrared-reflection detector(s)

13. The robot confinement system of claim 12, wherein the said infrared emitter(s) and infrared-reflection detectors can be placed in different parts of the robot

14. The robot confinement system of claim 13 wherein the said infrared emitters emit infrared at different angle(s) and/or direction(s) depending on their position as well as the position of the infrared reflection detector(s) in order to stop the said mobile robot at its encounter with the said black-out stripes.

15. The robot confinement system of claim 13 wherein said infrared emitters and infrared reflection detectors are located in pairs at bottom of the said robot.

16. The robot confinement system of claim 1, wherein the control unit slows down and/or stops the movement of the robot before turning it.
